(19) United States
(12) Patent Application Publication
(10) Pub. No.: US 2011/0241301 A1
(43) Pub. Date: Oct. 6, 2011

(54) Steering Assembly for a Two-Wheeler

(75) Inventor: Mickael Duvivier, Chatillon (FR)

(73) Assignee: MATRA MANUFACTURING & SERVICES, Paris (FR)

(21) Appl. No.: 13/072,483

(22) Filed: Mar. 25, 2011

(30) Foreign Application Priority Data
Apr. 1, 2010 (FR) FR1052488

(51) Int. Cl. B62K 21/10; B62K 3/00

(52) U.S. Cl. 280/63; 280/780

(57) ABSTRACT

Steering assembly for a two-wheeler comprising a frame, a handlebar and a fork holding a steering front wheel. The steering assembly comprises a head tube rigid with the frame and defining a swivel axis, a steering rod mounted swivelling through the head tube and connected on the one hand to the handlebar and on the other hand to the fork.

A torque generation device comprises an elastically deformable component arranged in a space inside the steering assembly and surrounding the steering rod. The elastic component having a first portion that cooperates with the tube and a second portion that cooperates with the rod, so as to create restoring torque when the steering rod swivels through at least a given angle with respect to a neutral angular position corresponding to travel in a straight line.

The invention relates to a steering system for a two-wheeler, in particular a bike or bicycle, which makes it possible to create restoring torque towards the neutral position of the steering.

More particularly, it is a steering assembly for a two-wheeler comprising a frame, a handlebar and a fork bearing a steering front wheel, which comprises:

a head tube rigid with the frame and defining a swivel axis;

a steering rod mounted swivelling through the head tube and connected on the one hand to the handlebar and on the other hand to the fork; and

a device capable of generating restoring torque.

It is known to provide an elastic return device for two-wheelers, whether bicycles, bikes or motorcycles, with the aim of realigning the steering front wheel with the neutral position of the steering that makes it possible to travel in a straight line. This is aimed at facilitating the return to this position by the user as much as possible, or even retaining this neutral position of the steering when the user lets go of the handlebar.

The known systems are most often produced using a spring-type elastic component, having one end fixed to the frame and another end fixed to the fork. These are therefore visible systems, which apart from being visually unattractive, can be damaged. The stability of the two-wheeler can then be impaired by generating torque towards a position that is offset with respect to the neutral position.

Furthermore, the existing systems for return to neutral position prove unsuitable for satisfactorily solving another problem found by the inventors. This problem arises when the steering of the two-wheeler arrives relatively suddenly in one of the maximum steering lock positions, either because the steering itself comprises stops limiting the angular amplitude of the steering, or because a component mobile with the fork stops against the frame. This stopping is of course unpleasant for a user and can slightly damage the parts coming into contact. This stopping phenomenon can also result in the bike falling over when the user, having got off the bike, rests it on a stand without making sure that the steering is stabilized. This phenomenon is accentuated when the bike comprises a front basket mobile with the fork, containing a load, or also if the stand is designed so that the front wheel loses contact with the ground when the bike is placed on the stand.

A purpose of the present invention is to produce an improved steering assembly making it possible in particular to prevent the angular stopping of the steering from generating an excessive shock, and to provide a device that is as reliable and visually pleasing as possible.

To this end, an object of the present invention is a steering assembly for two-wheelers of the abovementioned type, wherein the torque generation device comprises an elastically deformable component arranged in a inner space inside said steering assembly and surrounding the steering rod, said elastic component having a first portion that cooperates with the head tube and a second portion that cooperates with the steering rod, so as to create restoring torque about the swivel axis when the steering rod swivels through at least a given angle with respect to a neutral angular position corresponding to travel in a straight line, and wherein the inner space containing the elastically deformable component does not exceed the maximum section of the head tube.

The fact that the elastically deformable component is housed in an inner space makes it invisible and protects it from most risks of damage. The fact that this inner space surrounds the rod, and not the head tube, contributes to the compactness of the device.

But, furthermore, this situation in a relatively closed space, makes it possible to limit the amplitude of the deformations to which this elastic component is subjected, in particular by adopting certain of the preferential arrangements described in detail hereafter. It is thus possible to generate significant restoring torque when the steering approaches the maximum steering lock angles, while limiting the risks of permanent deformation of the elastic component.

In preferred embodiments it is also possible to make use of one or another of the following arrangements.

The elastically deformable component is essentially made of an elastomer; this material, apart from having a reasonable cost, has non-linear strength characteristics, in particular in compression, which makes it possible to greatly increase the restoring torque when approaching the maximum steering lock angles. Furthermore the fitting of an elastomer component proves easy, in particular due to the fact that it is not necessarily pre-stressed or fastened when put into position. Elastomers also have the advantage of having a wide range of stiffness that makes it possible to adjust the restoring torque depending on use, without modifying the shape of the elastic component.

The elastically deformable component is deformed mainly in a circumferential direction with respect to the swivel axis, i.e. in a direction corresponding to the torque generated, which allows for better control of the restoring torque and proves advantageous for the compactness of the device.

The inner space is delimited longitudinally by a lower annular wall and an upper annular wall immobilized longitudinally on the swivel axis close to the elastically deformable component; thus the longitudinal deformations can be limited.

The inner space is delimited radially outwards by a skirt extending longitudinally close to the elastically deformable component over a height at least equal to the height of said inner space; thus this skirt makes it possible to protect the elastic component but also to limit its deformations.

The first and second connection portions of the elastically deformable component are diametrically opposed; this allows for perfect symmetry of the device and therefore identical restoring torques in the event of left or right steering lock.

One of the portions of the elastically deformable component cooperates with a stop component that is adjustably mounted on one of said head tube and steering rod. Thus, it is possible to pre-stress the elastic component in order to increase the restoring torque, in particular close to the neutral angular position. This arrangement is also particularly useful in the case of an elastomer to prevent the appearance of play due to the compaction of this type of material after a series of compressions.

The elastically deformable component is presented in the form of a ring having generally flat longitudinal faces with first and second forms at the level of the first and second connection portions, and first and second stop components, complementary in shape to said forms, are rigid with the head tube and the steering rod respectively; the complementary shape of the first and second components transmits any angular displacement relative to the neutral position and thus the torque generation device performs a function of return to the neutral position in addition to its function of dampening steering lock-stop shocks.

The elastically deformable component comprises at least two separate elastic components generally in the form of an arc of circle and preferably having an enlarged median section coming into contact with walls of the inner space; this makes it possible to retain them in this space by friction.

The restoring torque generated by the elastically deformable component is at least 5 N/m for an angular displacement of less than 15 degrees with respect to the maximum steering lock angle; this is in order to very substantially dampen arrival in the stop position.

The restoring torque increases more than according to a directly proportional law as a function of the angular displacement of the steering rod with respect to the neutral steering position; this makes it possible to promote dampening for wide steering lock angles while only very slightly affecting the sensation of riding a two-wheeler.

The restoring torque generated by the elastically deformable component is less than 2 N/m for an angular displacement of 20 degrees with respect to the neutral position; thus riding two-wheelers under the most common traffic conditions is virtually unaffected and requires no adaptation phase.

Other characteristics and advantages will become apparent from the following description, given by as a non-limitative example of a preferred embodiment, with reference to the figures, in which:

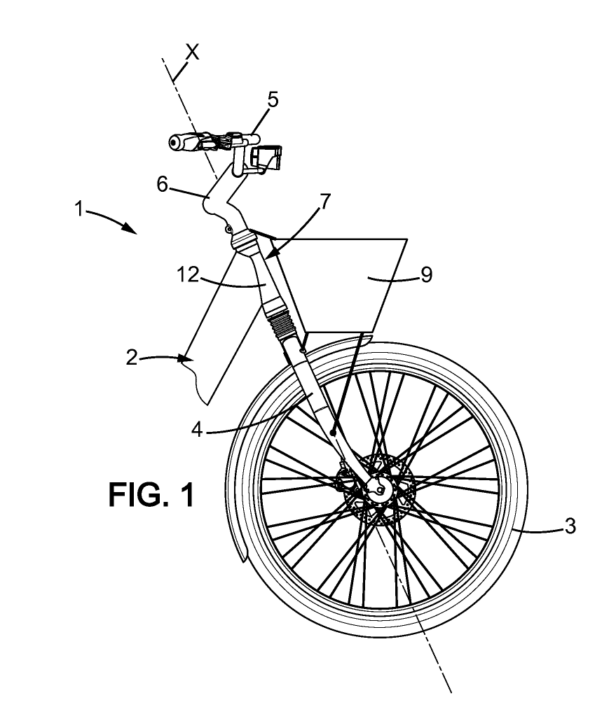

FIG. 1 is a partial view of a bike comprising a steering assembly according to the invention;

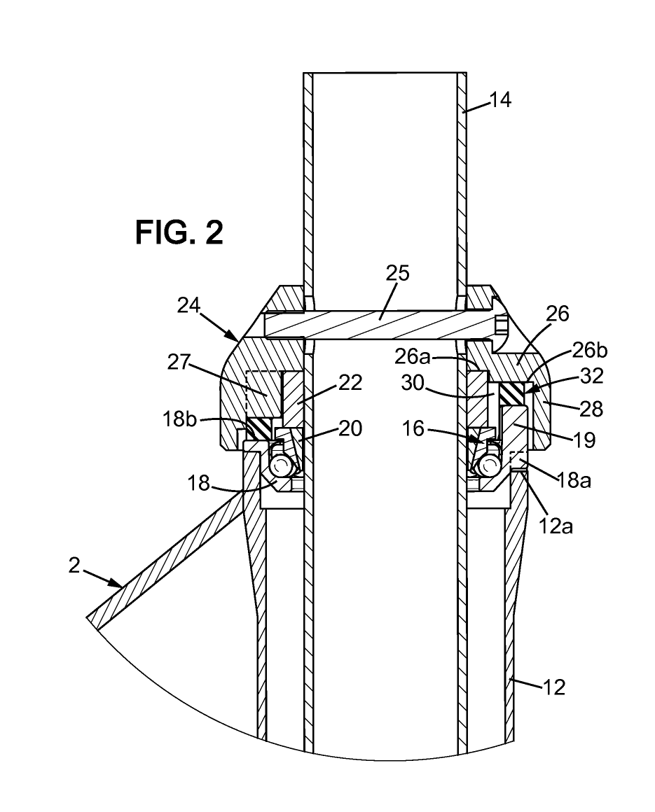

FIG. 2 is a longitudinal cross-sectional view of the steering assembly in FIG. 1,

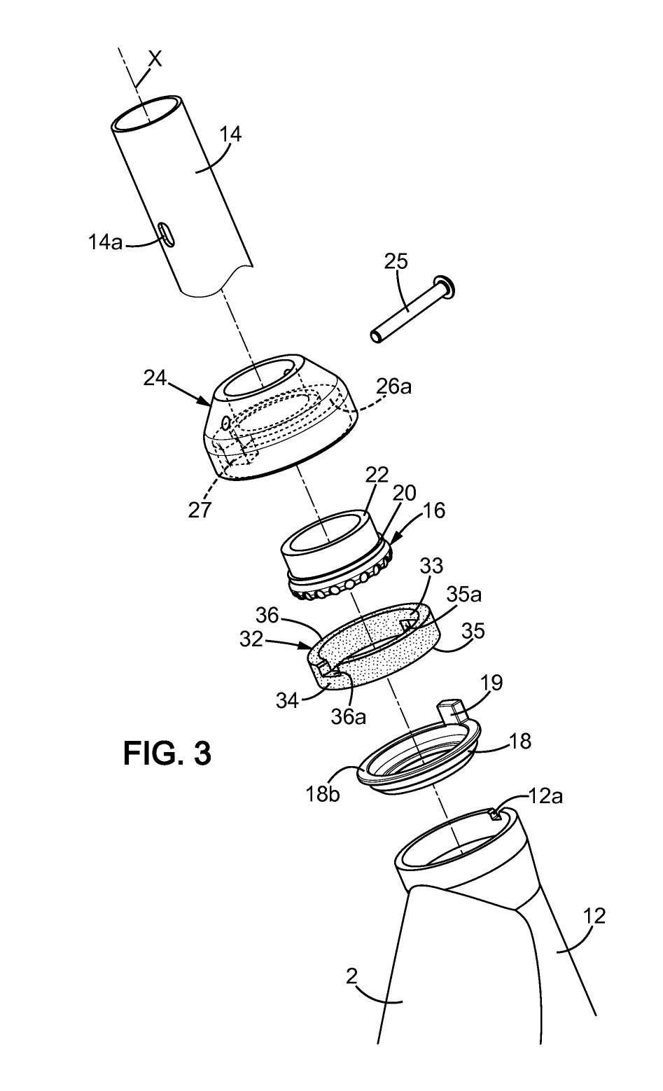

FIG. 3 is an exploded partial view of the steering assembly in FIG. 1; and

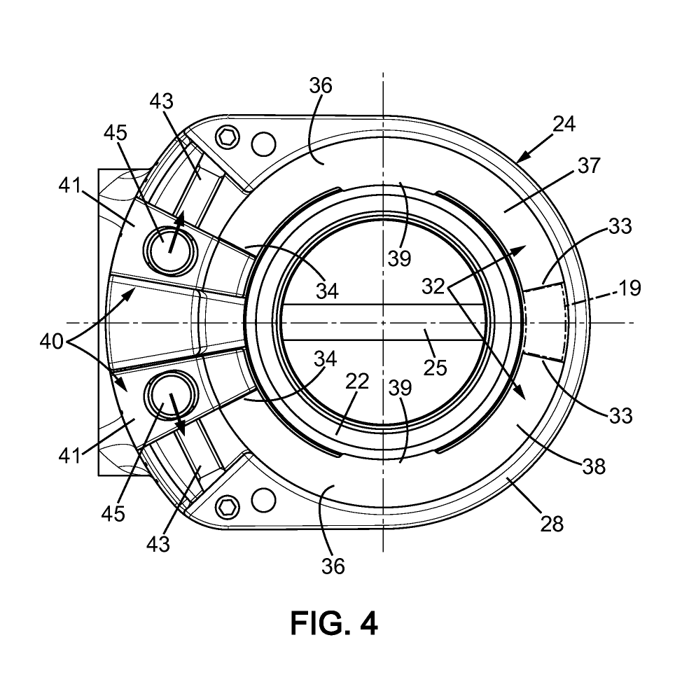

FIG. 4 is a cutaway view from below of an alternative embodiment.

In the same figures, identical reference numbers designate identical or similar components.

FIG. 1 shows the front part of a bike 1 comprising a frame 2, a front wheel 3 held by a fork 4 and a handlebar 5 held by a stem 6. It is a two-wheeler of the bike or bicycle type optionally comprising electric pedal assistance. However it will be understood from the remainder of the description that it could be another type of two-wheeler such as for example a scooter or a light motorbike.

A steering assembly 7 ensures steering by swivelling of the wheel 3, the fork 4, the stem 6 and the handlebar 5 about an axis X called the swivel axis. For well-known reasons of stability, the swivel axis X is slightly inclined with respect to the vertical. Under certain conditions of use, this inclination can nevertheless have the drawback that the steering of the two-wheeler tips by gravity towards a right or left maximum steering lock angle. This phenomenon arises due to the offset of the centre of gravity of the wheel 3 with respect to the swivel axis X, for example when the steering wheel 3 no longer touches the ground when the bike 1 is placed on a stand. This phenomenon is amplified due to the presence of a load that is off-centre with respect to the swivel axis X. This is in particular the case when baggage is placed in a basket 9, shown by way of illustration, that is mobile with the fork 4 and the stem 6.

The tipping by gravity of the steering results in a more or less significant jerk. During use other causes can result in this stopping of the steering which, apart from being unpleasant, can damage the bike or even cause it to fall over.

The steering assembly 7 also makes it possible to overcome this problem. As it will appear more clearly from FIGS. 2 and 3, the steering assembly 7 comprises a head tube 12, also called a vertical tube, that is rigid with the frame 2 and oriented along the swivel axis X since it defines this axis. By the term “tube” is meant that this is a somewhat elongated hollow body, in one or more parts. But this in no way means that it must represent a cylindrical or regular outer or inner surface.

The steering assembly 7 comprises a steering rod 14 that passes through the head tube 12 and swivels in the latter about the axis X. The term “rod” does not mean that this is a solid body, or in one piece. It can be a tubular body as in the embodiment shown, and the outer surface is not necessarily cylindrical or regular. In the embodiment shown, the steering rod 14, only the upper part of which is shown in FIG. 3, is rigid with the fork 4, as is usual. But it is not ruled out that the steering rod 14 is an extension of the stem 6.

Precise swivelling with a slight effort of the steering rod 14 in the head tube 12 is ensured in well-known manner by an upper ball bearing 16, which can be seen in FIGS. 2 and 3, and a lower ball bearing, not shown. These ball bearings form swivelling bearings that form a radial space between the outer wall of the steering rod 14 and the inner wall of the head tube 12.

The balls of the upper bearing 16 run on a track formed on a pierced bearing cup 18 resting on the head tube 14, and more precisely on the inner rim of the latter. In the embodiment shown, the bearing cup 18 is a separate part from the head tube 12 and simply rests on the latter, but it could joined to the tube 12, for example by welding.

It will be noted that the bearing cup 18 is immobilized in rotation with respect to the tube 12 by the cooperation of a projection 18a protruding from the bearing cup, which can be seen in FIG. 2, with a complementary notch 12a formed in the upper end of the tube 12, as can be seen more clearly in FIG. 3.

The bearing cup 18 constitutes a lower annular wall 18 surrounding the rod 14 and immobilized longitudinally. The outer rim of the inner wall 18 forms a flat circular surface portion 18b except a component 19 and is oriented upwards.

The stop component, which is presented in the form of a relatively square stud, extends upwards from the surface portion 18b. This first stop component 19 could take other forms, even a hollow form, as long as it is immobilized in rotation with respect to the head tube 12.

The ball cage 16 is locked onto the steering rod 14 by a tapered ring 20. A spacer 22 rests on the tapered ring 20 and optionally the ball cage 16.

A cap 24 rests on the spacer 22. The cap 24 is immobilized longitudinally and in rotation with respect to the steering rod 14, or also by producing the cap 24 in one piece with the stem 6. In the embodiment shown, this immobilization is ensured by a screw 25 passing through openings 14a in the rod and exerting an action of clamping the cap 24 on the steering rod 14.

Other immobilization systems are of course possible, such as for example a system of nuts and counter-nuts screwed onto the rod 14. Furthermore, the cap 24 can take a substantially different form. For the embodiment shown, it is important that the cap 24 has a so-called upper annular wall 26, which extends generally radially from the rod 14. The upper annular wall 26 has a first circular surface 26a resting against the spacer 22, thus blocking any downward movement of the steering rod 14. The upward sliding of the steering rod 14 is blocked in known manner at the level of the lower part of the head tube 12, in particular by the lower bearing.

The upper annular wall 26 has a second flat circular surface portion 26b oriented downwards that is situated essentially facing the surface portion 18b of the inner wall 18.

The upper annular wall 26 has a second stop component 27 rigid with the latter, and as a result immobilized in rotation with respect to the steering rod 14. In the embodiment shown, the second stop component 27 is presented in the form of a projection, delimited by dashed lines in FIGS. 2 and 3, which extends downwards from the surface portion 26b and along the skirt 28.

The cap 24 has an outer skirt 28 which, in the embodiment shown, extends longitudinally downwards from the outer rim of the upper annular wall 26. The skirt 28 preferably extends over a height at least equal to the space separating the lower 18 and upper 26 annular walls, so as to mask this space from the outside. The skirt 28 is a rigid metal wall, the inner diameter of which is slightly greater than the maximum diameter of the tube 12.

The skirt 28, the lower annular wall 18, the upper annular wall 26 and the steering rod 14 with the spacer 22, delimit an inner space 30 of the steering assembly 7. Here, the inner space 30 takes the form of a ring which is square in cross-section, outside the first and second stop components (19, 27). The inner space 30 is not necessarily sealed but prevents the introduction of foreign objects. More particularly, the inner space 30 is delimited by the cylindrical surface portion 18b of the lower annular wall 18, the surface portion 26b of the upper wall 26 and the radially outer surface of the spacer 22, which forms a single functional assembly with the steering rod 14 and could be formed in a single piece with the latter. It will be noted that the inner space 30 does not exceed the maximum section of the head tube 12, and does not therefore create a marked protuberance with respect to this tube.

The steering assembly 7 comprises an elastically deformable component 32 that forms a device making it possible to generate torque about the swivel axis X, which returns the rod 14 towards the neutral angular position of the steering, a neutral position which must allow for the movement of the two-wheeler substantially in a straight line.

The space requirement of the elastically deformable component 32 does not exceed the maximum section of the head tube 12. The elastically deformable component 32 is housed in the inner space 30 of the steering assembly 7, and is therefore protected. Here, this is a ring that completely surrounds the steering rod 14 and is situated between the latter and the skirt 28. The elastically deformable component 32 has a first portion 33 (also called a connection portion) connected to the head tube 12 and a second portion 34 (also called a connection portion) connected to the steering rod 14, so that it generates a restoring torque due to its elastic deformation when the angular position of the steering rod 12 moves away from the neutral position.

The ring 32 forming the elastically deformable component has substantially flat upper and lower longitudinal surfaces (35, 36). The latter each have a notch (also called form) (35a, 36a) exactly complementary in shape to the first and second stop components (19, 27). There is therefore no play between the ring 32 and the stop components, so that a slight angular displacement with respect to the neutral position between the head tube and the steering rod (12, 14) results in a deformation, and results in a restoring torque, even if this is slight. The torque generation device therefore performs a function of returning the steering to a straight line. It is possible to provide a brake component, such as for example a wave washer between the bearing cup 18 and the elastic component 32, in order to slow down the return to the neutral position.

Nevertheless, it is not absolutely necessary to perform this function in order to avoid the problems of shocks when the steering tips towards a maximum steering lock position. It is therefore perfectly possible to envisage the provision of angular play between one and/or the other of the stop components (19, 27) and the corresponding form (35a, 36a) of the ring 32. It is even possible to envisage providing for the elastically deformable component to be C-shaped with a first portion 33 connected in fixed manner to the head tube 12 and a second portion in the form of a free space surrounding the second stop component in order to produce a connection allowing for displacement of the steering over a predetermined angular range, without resulting in deformation of the elastically deformable component and therefore without creating restoring torque over this range centred on the neutral position. A structure with two elastic components is also possible.

On the other hand, in order to avoid a stopping phenomenon in the event of tipping towards the maximum steering lock angles, it is important to generate relatively high restoring torque when these angular positions are approached. To this end, it proves preferable that the elastically deformable component 32 is subjected to stresses and therefore deformations in a circumferential direction with respect to the swivel axis X. This is typically the case when producing this component in the form of the ring 32 which, between the first and second portions (33, 34) is subjected on the one hand to tensile stress resulting in an elongation on one side and, on the other hand, a compressive stress resulting in the first and second portions getting closer together on the other side.

The ring 32 is made of an elastomer. The use of a metal torque-generating component via a helical spring the ends of which would be connected to the tube and to the steering rod respectively is not ruled out. The restoring torque would then be directly proportional to the swivel angle due to the virtually constant torsional stiffness over the angular ranges used. But using an elastomer proves much more effective for generating high restoring torque close to the maximum steering lock angles without the steering of the two-wheeler having high stiffness about the neutral position, which could produce an unpleasant feeling for certain users. The stiffness characteristics of an elastomer material, which follow non-proportional laws, in particular in compression, make it possible to see a greater increase in the restoring torque than according to a law directly proportional to the angular displacement with respect to the neutral position. A combined effect can be obtained with the fact that the elastically deformable ring 32 is arranged in a relatively adjusted inner space 30. When the compressed portion of the ring 32 comes into contact with the walls of this space, its resistance to deformation increases greatly.

By way of example, the elastomer material, the geometric dimensions of the ring 32 and of the inner space 30 are chosen so as to generate restoring torque of at least 5 N/m for a position situated 15 degrees before the maximum steering lock angle. For example, from 5 N/m to 8 N/m for an angle of 30° according to the more or less soft or hard sensation sought. The maximum steering lock angle corresponds to the angle that a user can reasonably reach without damaging the bike. As an indication, the maximum steering lock angle can be limited to +/−45° for a city bike, and the restoring torque from 7 to 15 N/m a few degrees before this angle.

Such a value of the restoring torque with a metal spring would require significant torsional stiffness and prestressing, which the user could find unpleasant under normal traffic conditions. With the same elastically deformable ring 32, the restoring torque can remain below 2 N/m for a range of +/−20 degrees about the neutral position. Such restoring torques do not substantially affect the riding of the two-wheeler, but all the same make it possible to perform a function of return to neutral position which makes it easier to remain on course without holding the handlebar. Restoring torque close to the neutral angular position improves the feeling of safety, and avoids a significant inclination of the steering in a parking position.

The values indicated above are only preferential values determined more particularly for an adult cycling in town. The structure of the steering assembly 7 and of the embodiment shown, however, allows for easy adjustment of these values depending on the user or the use.

As can be seen in FIGS. 2 and 3, the first and second portions (33, 35) of the elastically deformable component 32 are diametrically opposed in neutral position. As a result the complementary portions of the ring 32 which are capable of deformation, are relatively large. The maximum steering lock angle remains relatively large, without however exceeding +/−150 degrees due to the stops (19, 27). Multiplying the connection portions is not however ruled out if the steering lock angle can be distinctly smaller. The diametrically opposed arrangement of the portions (33, 34) is combined with the use of an elastomer ring in order to offer perfectly symmetrical behaviour on the right and on the left of the steering assembly 7.

As can be seen in FIG. 2, the height of the inner space 30 between the top of the first and second stops and the facing first and second annular walls, substantially corresponds to the height of the ring in these zones, i.e. the first and second portions (33, 34) of the latter. This height can even be slightly less than the height of these portions (33, 34) so as to slightly compress them in the longitudinal direction. This makes it possible to avoid any disengagement of the notches (33a, 34a) with the first and second stops (19, 27) therefore increasing the reliability of the return device.

Outside these first and second portions, such matching of the height of the inner space 30 with the height of the ring is not necessary. It is even preferable to provide play between the longitudinal faces (35, 36) of the ring and the upper and lower annular walls (26, 18), at least when the steering is in the neutral position. On the other hand, in order to limit the deformations of the elastomer ring 32 and significantly increase the restoring torque, it is preferable that the longitudinal faces (35, 36) of the ring come into contact with the upper and lower annular walls (26, 18) when the steering approaches a maximum steering lock angle.

Similar arrangements are also perfectly applicable to the radially inner wall of the skirt 28 and the radially outer wall of the steering rod assembly, here constituted by the spacer 22. The width of the inner space 30 is then adjusted with respect to the width of the ring 32, in order to create a contact for a compressed portion.

FIG. 4 shows an alternative embodiment in which the elastically deformable component 32, the stop component 27 rigid with the steering rod 14, as well as the cap 24 of this rod, are substantially different, the other pieces being identical, in particular the bearing cup 18 and its stop component 19 the outline of which is indicated in chain-dotted lines.

Here, the elastic component 32 is formed by two separate elements (37, 38). These components are presented in the form of a portion of an arc of circle with a rectangular cross-section. FIG. 4, showing the somewhat modified cap 24 viewed from below, shows the lower longitudinal face 36 of these elements (37, 38). A median portion 39 of each of these components has a larger section, here produced by an extra thickness in the radially inner steering, so that this median portion 39 comes into contact with the outer skirt 28 and the spacer 22. Thus, the elements (37, 38) can be retained in the cap 24 before being assembled on the head tube 12.

In this embodiment variant, the stop component 27 rigid with the steering rod 14 is replaced by an adjustable stop system 40.

As in the previous embodiment, the elements (37, 38) of the elastically deformable component have first and second portions (33, 34), corresponding here to the circumferential end surfaces, which cooperate with the stop component 19 immobile with respect to the head tube 12 and stop components 40 that are rigid with the steering rod 14 during use, but the position of which can be adjusted. These adjustable stop components 40 each comprise a stopper 41 mounted sliding on an arc of circle of the cap 24. A threaded rod has a head mounted rotating in the cap 24 and a threaded part that cooperates with a slider 45 carrying the corresponding stopper 41.

Thus, the elastic components (37, 38) can be placed between the fixed stop component 19 and the adjustable stops 40 in the position shown in FIG. 4, without being circumferentially compressed or while being slightly compressed. The threaded rods 43 are then turned in order to move each slider 45 and the associated stop 41 in the direction of the arrows in FIG. 4. The elastic elements (37, 38) are then circumferentially compressed, which makes it possible to increase the restoring torque about the neutral position, but also to avoid play appearing during use between the first and second portions (33, 34) and the stop components (19, 40), due to the inevitable compaction of the elastomer.

Of course, other embodiments of the adjustable stop components are possible. It must be noted that the elastically deformable elastomer component is advantageously greased in order to avoid the occurrence of noise.

The embodiment described above, intended in particular for a two-wheeler of the city bike type, is in no way limitative. Numerous modifications can be made to the steering assembly 7 or to the two-wheeler comprising this assembly, without exceeding the scope of the present invention defined by the claims below.

In addition to the possibilities already indicated, it is in particular possible to provide that the skirt 28 externally delimiting the inner space 30 is not rigid with the steering rod 14 in order to form an assembly with the latter, but rather forms an assembly with the head tube 12. For example, the skirt could be in the form of a collar extending upwards from the bearing cup 18, or formed by the head tube 12 itself. The skirt 28 could also be an independent element arranged between the assemblies forming the head tube and the steering rod.

1. Steering assembly for a two-wheeler comprising a frame, a handlebar and a fork holding a steering front wheel, which comprises:
a head tube rigid with the frame and defining a swivel axis;
a steering rod mounted swivelling through the head tube and connected on the one hand to the handlebar and on the other hand to the fork; and
a device capable of generating restoring torque towards a neutral angular position corresponding to travel in a straight line,
wherein the torque generation device comprises an elastically deformable component arranged in a space inside said steering assembly and surrounding the steering rod, said elastic component having a first portion that cooperates with the head tube and a second portion that cooperates with the steering rod, so as to create restoring torque about the swivel axis when the steering rod swivels by at least a given angle with respect to said neutral angular position,
wherein the inner space containing the elastically deformable component does not exceed the maximum section of the head tube.

2. Steering assembly according to claim 1, in which the elastically deformable component is essentially made of an elastomer.

3. Steering assembly according to claim 1, in which the elastically deformable component is deformed mainly in a circumferential direction with respect to the swivel axis.

4. Steering assembly according to claim 1, in which the inner space is delimited longitudinally by a lower annular wall and an upper annular wall immobilized longitudinally on the swivel axis close to the elastically deformable component.

5. Steering assembly according to claim 1, in which the inner space is delimited radially outwards by a skirt extending longitudinally close to the elastically deformable component over a height at least equal to the height of said inner space.

6. Steering assembly according to claim 1, in which the first and second connection portions of the elastically deformable component are diametrically opposed.

7. Steering assembly according to claim 1, in which one of the first and second portions of the elastically deformable component cooperates with a stop component that is adjustably mounted on one of said head tube and steering rod.

8. Steering assembly according to claim 1, in which the elastically deformable component is presented in the form of a ring having generally flat longitudinal surfaces with first and second forms at the level of the first and second connection portions, and in which a first and a second stop component with a shape complementary to said forms are respectively rigid with the head tube and the steering rod.

9. Steering assembly according to claim 1, in which the elastically deformable component comprises at least two separate elastic elements generally in the form of an arc of circle and preferably having a median portion of enlarged section coming into contact with walls of the inner space.

10. Steering assembly according to claim 1, in which the restoring torque generated by the elastically deformable component, is at least 5 N/m for an angular displacement of less than 15 degrees with respect to the maximum steering lock angle.

11. Steering assembly according to claim 1, in which the restoring torque increases more than in accordance with a directly proportional law as a function of the angular displacement of the steering rod with respect to the neutral position of the steering.

12. Steering assembly according to claim 1, in which the restoring torque generated by the elastically deformable component is less than 2 N/m for an angular displacement of 20 degrees with respect to the neutral position.

13. Bike comprising a frame, a handlebar and a fork holding a steering front wheel, and comprising a steering assembly according to any one of the previous claims.
